(19) United States
(12) Patent Application Publication
(10) Pub. No.: US 2022/0221772 A1
(43) Pub. Date: Jul. 14, 2022

(54) DETECTION DEVICE HAVING AN IMAGE CAPTURING DEVICE AND A CARRIER MEDIUM, AND DETECTION SYSTEM INCLUDING SUCH A DETECTION DEVICE AND A DEVICE WITH A SCREEN

(71) Applicant: AUDI AG, Ingolstadt (DE)

(72) Inventors: Markus KLUG, Ingolstadt (DE); Tobias MOLL, Ingolstadt (DE); Johannes SCHEUCHENPFLUG, Baar-Ebenhausen (DE)

(73) Assignee: AUDI AG, Ingolstadt (DE)

(21) Appl. No.: 17/608,248

(22) PCT Filed: Apr. 30, 2020
(86) PCT No.: PCT/EP2020/062089

§ 371 Date: Nov. 2, 2021

(30) Foreign Application Priority Data
May 3, 2019 (DE) 10 2019 206 364.0

(51) Int. Cl. G03B 17/17; G03H 1/02; G03B 13/36; H04N 5/232; H04N 5/225

(52) U.S. Cl. CPC G03B 17/17; G03H 1/0244; G03H 1/0248; H04N 5/2256; H04N 5/232123; H04N 5/2257; H04N 5/232121; G03B 13/36

(57) ABSTRACT

A carrier medium embodied as a light guide has an input coupling region and an output coupling region, each of which are embodied as a holographic element. The carrier medium forms a cover plate for an image display region of a screen and the input coupling region is at least one partial region of the cover plate surface. Light incident on the input coupling region from the surroundings is coupled into the carrier medium, transmitted to the output coupling region by internal reflection and is in turn coupled out from the output coupling region. The coupled-out light is captured by an image capturing device and used to generate image data correlated with the captured light.

### CROSS REFERENCE TO RELATED APPLICATIONS

This application is a U.S. national stage of International Application No. PCT/EP2020/062089, filed on Apr. 30, 2020. The International Application claims the priority benefit of German Application No. 10 2019 206 364.0 filed on May 3, 2019. Both the International Application and the German Application are incorporated by reference herein in their entirety.

### BACKGROUND

Described below are a detection device having an image capturing device and a carrier medium, a detection system with such a detection device, and a device with a screen.

A device with a screen, such as a mobile terminal, for example, generally includes a photographic and/or video-based detection device, such as a camera device, for example, in order to be able to generate an image representation of the surroundings of the device and display it on the screen of the device, for example. In order to integrate the detection device into the device, a camera sensor is often positioned on a front side of the device, but the screen is additionally arranged on the front side. As a result, a surface area of the screen becomes areally smaller than a surface area of the front side of the device, since the camera sensor has to be positioned for example clearly visibly in the region of an edge of the screen that is not encompassed by an image display region of the screen. As a result of this positioning, however, during a video conference by the mobile terminal, for example, a user is given the impression that, when looking centrally at the screen, the user in his/her image representation is not looking directly into the detection device, that is to say into the camera sensor of the device. Furthermore, for the described positioning of the camera sensor, a small camera sensor is often chosen in order to be able to maintain the largest possible display region. The small camera sensor has a diameter of just 5 millimeters, for example. A size of the usable optical system is thus limited, which results in a restricted image quality of the image representation recorded by the detection device. This is because, firstly, the pixels are smaller in the case of a small camera sensor, as a result of which less light can be gathered. Secondly, the optical system turns out to be correspondingly small, as a result of which the depth of field turns out to be very high (parallel beam path) and, since the entrance opening is so small, less light is captured. Moreover, such a small camera sensor can easily be covered inadvertently by the user, for example by a finger of the user placed on the camera sensor. Furthermore, in the case of soiling the small camera sensor can easily be completely soiled and thus covered.

In the related art, optical diffraction gratings are produced holographically and are therefore referred to as holographic gratings. In this regard, the scientific publication “Volume-phase holographic gratings and their potential for astronomical applications” (S. C. Barden, J. A. Arns and W. S. Colburn, Proceedings SPIE 3355, Optical Astronomical Instrumentation, 1998) discloses the fact that light which impinges on such a holographic grating at an angle that is distinctly outside the angular range that satisfies the Bragg condition passes through the holographic grating without being diffracted. However if light impinges on the holographic grating from an angle so that the Bragg condition is at least approximately satisfied, the light is diffracted at an angle. A similar behavior is manifested with regard to a wavelength dependence of the influence of the holographic grating on light. This is because light having a wavelength that lies distinctly outside the wavelength range that is predefined by the Bragg condition as the so-called Bragg wavelength likewise passes through the holographic grating without being diffracted and only light having a wavelength that at least approximately satisfies the Bragg condition is diffracted at the holographic grating. Use of complex holographic grating structures make it thus possible, for example, for light with two different wavelength ranges to be diffracted at the same angle in each case. Moreover, for example, a holographic grating can split light having different wavelengths into different light paths, such that a dispersive beam splitter can be realized with the aid of a holographic grating.

### SUMMARY

A solution to issues in the prior art is the provision of an inconspicuous photographic and/or video-based detection device for a device with a screen.

The detection device includes an image capturing device and a carrier medium. The carrier medium serves as a cover plate for a screen and is realized for example as a plate composed of transparent plastic or glass, wherein the carrier medium additionally forwards light from the surroundings to the image capturing device. The carrier medium is thus embodied as a light guide, that is to say that the carrier medium constitutes a light guiding medium. That is to say that the carrier medium can forward light that is coupled into the carrier medium to the image capturing device by internal reflection, such as total internal reflection. The image capturing device can then capture the forwarded light when it is coupled out of the carrier medium again and produce or generate image data therefrom. Preferably, the image capturing device can be realized as an image sensor or a camera, in each case with or without an imaging optical unit (such as, for example, a lens element or a system of lens elements). The image capturing device is thus designed for generating an image representation of the surroundings. The detection device is thus overall a device for recording static or moving images representing an image representation of the surroundings of the detection device. The light required for this purpose is detected or captured at a surface of a screen by a light-guiding carrier medium embodied as a cover plate.

For the purpose of coupling the light in or out, an input coupling region and an output coupling region are arranged on the carrier medium. The carrier medium with the input coupling region and the output coupling region are embodied jointly as the cover plate for an image display region of the screen. These three components of the detection device are thus designed to be positioned on the image display region of the screen, wherein this can involve for example a surface of a touch-sensitive screen of a mobile terminal, such as a smartphone. In this example, the carrier medium with the input coupling region thus forms a cover plate for a front side of the smartphone, on which the image display region of the screen of the smartphone is arranged.

The input coupling region may be formed at least in a partial region of a surface of the cover plate which is configured for covering the image display region. In the case where the detection device is positioned in the installation position, that is to say on the image display region of the screen, the input coupling region is arranged on a side of the cover plate facing away from the screen, such as parallel to a plane of the image display region. The input coupling region is embodied as a holographic element with a first deflection structure. A description of the functioning of such a holographic element, which is often referred to as an optical grating and can be produced by holographic methods, may be found for example in the scientific publication cited above. The input coupling region can accordingly be realized for example as a diffraction grating. The first deflection structure of the input coupling region is configured to couple light that is incident on the first deflection structure from the surroundings into the carrier medium and in the process to deflect it so far or to such a great extent that the coupled-in light satisfies the critical angle condition.

The carrier medium is accordingly configured to then transmit the coupled-in light from the input coupling region to the output coupling region by internal reflection. The light that is incident on the first deflection structure from the surroundings and is coupled into the carrier medium can in this case be guided in zigzag-like movements along a direction parallel to a plane of the surface of the image display region of the screen. A prerequisite for this is that the detection device is arranged in the installation position, that is to say on the image display region of the screen. Finally, the output coupling region, which is likewise embodied as a holographic element, has a second deflection structure, which is configured to couple the light that is transmitted in the carrier medium and is incident on the second deflection structure out of the carrier medium. The second deflection structure of the output coupling region can for example likewise be realized as a diffraction grating.

In other words, overall the light from the surroundings can be deflected or diffracted at the first deflection structure of the input coupling region and be coupled into the carrier medium. Correspondingly, the light that is transmitted by the carrier medium can be deflected or diffracted at the second deflection structure and there be coupled out of the carrier medium again. The light can thus be captured or picked up upstream of or on the image display region of the screen of a device.

In order to capture the light coupled out from the carrier medium, the image capturing device lies against the output coupling region. As described above, the image capturing device is configured to capture the light that is coupled out from the carrier medium and to provide it in the form of image data. In this case, the image data are correlated with the incident light from the surroundings. In order to secure the image capturing device to the carrier medium, the image capturing device can be adhesively bonded to the carrier medium for example. Alternatively, the carrier medium can be clamped in a holding device of the image capturing device. The image capturing device can be embodied in particular as an image sensor, for example as a CCD sensor (Charged Coupled Device) or as a CMOS sensor (Complementary Metal Oxide Semiconductor). In the case of this configuration of the image capturing device as an image sensor, the carrier medium on which the input coupling region and the output coupling region are arranged can additionally perform the task of a lens, that is to say of an imaging optical unit. Alternatively, the image capturing device can also be realized as a camera or a photographic apparatus, in particular as a microcamera, such as is embodied for example in a smartphone, with a dedicated imaging optical reader.

The entire input coupling region of the detection device thus serves as a capture region for the light that is ultimately forwarded to the image capturing device and provided there as image data correlated with the light. The input coupling region thus forms a kind of camera lens or light inlet for the image capturing device. The input coupling region therefore may encompass an entire side of the cover plate, specifically that side of the cover plate which faces away from the screen in the installation position. This affords the advantage that the capture region of the detection device encompasses the entire side of the cover plate. As a result, a camera sensor arranged for example in the edge region of the touch-sensitive screen of the smartphone becomes superfluous since the cover plate of the smartphone itself can serve as a camera sensor if the above-described cover plate of the detection device is used as the cover plate of the smartphone.

By virtue of the fact that only a single image capturing device, for example a single camera sensor, is necessary for capturing the image, in addition less computing power is required and the manufacturing outlay for producing the detection device is less than the manufacturing outlay for known camera devices, for example.

The detection device described makes it possible overall for the capture region, that is to say the input coupling region, to be positionable on the image display region of the screen, such that ultimately the image data that are correlated with the light that impinged on the region of the image display region are provided by the image capturing device. As a result, firstly, disturbing elements on the image display region are obviated since the cover plate is configured in such a way that it can completely encompass the image display region, such that the image display region of the screen no longer has a cutout arranged in it for the camera sensor, as is the case in conventional smartphones, for example. The resultant enlargement of the capture region to encompass the entire surface area of the cover plate additionally makes it unlikely that the capture region will be covered or at least shaded, for example owing to unfavorably chosen positioning of the user's finger, since light for the desired imaging is recorded over a larger area than in the conventional camera sensor described above. Moreover, additional optical elements, such as the camera sensor installed in the smartphone, can be obviated, whereby costs are reduced, a weight of the end product, that is to say of the mobile terminal with integrated detection device, is reduced and a complexity of the camera device integrated into the mobile terminal is additionally reduced. All this is possible since a cover plate for the image display region of the screen, in addition to its covering function, is configured as a capture region for a detection device. This makes the actual camera device seemingly invisible to the user since, instead of a conventional camera sensor of a camera device, only the carrier medium with the input coupling region and the output coupling region, which are embodied overall as a light-transmissive cover plate, for example, are visible to the user when the user looks at the image display region of the screen. The detection device is thus particularly inconspicuous.

One embodiment provides for the input coupling region and the output coupling region to have at least one optical grating, in particular a surface holographic grating or a volume holographic grating, as deflection structure. In this context, the detection device can also be referred to as HoloCam, short for holographic camera.

An optical grating, also called diffraction grating, and its mode of operation and production method are generally known, as already mentioned, as evident for example from the scientific publication cited above. In principle, an optical grating can be based on structures which are periodic at least in sections, a so-called grating structure, in a substrate. With such a grating structure, an optical grating can employ the physical effect of diffraction to bring about light guiding, as is known for example from mirrors, lens elements or prisms. If light is incident on the optical grating, i.e. if light rays are incident thereon, the incident light rays satisfying the Bragg equation in particular, the light rays are diffracted or deflected by the optical grating. The light guiding can thus be effected in particular by interference phenomena of the light rays diffracted by the optical grating. The deflection structure of the input coupling region or output coupling region can accordingly also be referred to as a diffraction structure.

Preferably, an optical grating can be embodied in a directionally selective manner or in an angularly selective manner vis-à-vis the incident light. Thus, only light, in particular a portion of the light, which is incident on an optical grating from a predetermined direction of incidence, for example at a predetermined angle, can be deflected. Light, in particular a portion of the light, which is incident on the optical grating from a different direction may not be deflected, or deflected to a lesser extent the greater the difference relative to the predetermined direction of incidence. That portion of light which deviates from the predetermined direction of incidence or optimum direction of incidence can thus propagate through the substrate with the optical grating in an unimpeded manner.

Additionally or alternatively, an optical grating can also be embodied in a wavelength-selective manner or in a frequency-selective manner. Thus, only light, in particular a first portion of the light, having a predetermined wavelength can be deflected or diffracted at a specific diffraction angle by the optical grating. Light, in particular a second portion of the light, having a different wavelength than the predetermined wavelength may not be deflected, or deflected to a lesser extent the greater the difference relative to the predetermined wavelength. The second portion of light, deviating from the predetermined wavelength or optimum wavelength, can thus propagate through the substrate with the optical grating in an unimpeded manner. As a result, for example, at least one monochromatic light portion can be split off from polychromatic light that impinges on the optical grating. Advantageously, the deflection effect is maximal for the optimum wavelength and decreases or becomes weaker toward longer and shorter wavelengths, for example in accordance with a Gaussian bell. In particular, the deflection effect acts only on a fraction of the visible light spectrum and/or in an angular range of less than 90 degrees.

An optical grating can be produced in particular by the exposure of a substrate, that is to say for example photolithographically or holographically. In this context, the optical grating can then also be referred to as a holographic grating or a holographic optical grating. Two types of holographic optical gratings are known: surface holographic gratings (for short: SHG) and volume holographic gratings (for short: VHG). In the case of a surface holographic grating, the grating structure can be produced by optical deformation of a surface structure of the substrate. Impinging light can be deflected, for example reflected, by the altered surface structure. Examples of surface holographic gratings are so-called sawtooth or blazed gratings. In contrast thereto, the grating structure in the case of volume holographic gratings can be incorporated into the entire volume or a partial region of the volume of the substrate. Surface holographic gratings and volume holographic gratings are generally frequency-selective. However, optical gratings that can diffract polychromatic light are also known. These optical gratings are referred to as multiplexed volume holographic gratings (for short: MVHG) and can be produced for example by altering the periodicity of the grating structure of an optical grating or by arranging a plurality of volume holographic gratings one behind another.

Suitable material for the substrate for incorporating an optical grating is particularly a polymer, in particular a photopolymer, or a film, in particular a photosensitive film, for example composed of plastic or organic substances. Substrates having a deflection structure for diffracting light, for example in the form of an optical grating, can also be referred to as holographic optical elements (HOE).

The described embodiment of the input coupling region and of the output coupling region therefore enables the light that is incident on the input coupling region to be diffracted to the image capturing device arranged laterally on the cover plate, for example, as a result of which the cover plate of the detection device can be designed in such a way that the image capturing device does not cover the image display region of the screen at all, i.e. not even partly, in the installation position of the detection device.

A further embodiment provides for the input coupling region and the output coupling region to be embodied integrally with the carrier medium or for the carrier medium to be embodied as a separate element with respect to the input coupling region and the output coupling region.

In the first case, the input coupling region and the output coupling region can thus be incorporated for example directly into a surface of the carrier medium. That is to say that the deflection structure can be introduced into the surface of the carrier medium (cover plate surface) by etching or laser treatment, for example. The carrier medium itself can thus be embodied as HOE. In the second case, input coupling region, output coupling region and carrier medium can be embodied separately. Here the input coupling region and the output coupling region can form at least one first element, for example, and the carrier medium can form a second element bearing against the first element. The input coupling region and the output coupling region can thus be embodied in at least one HOE. By way of example, the input coupling region and the output coupling region can be embodied in different sections of a holographic film or plate. In order to secure the film or plate to the carrier medium, the film or plate can be adhesively bonded onto the carrier medium. Alternatively, the holographic film can also be embodied as an adhesion film and adhere to the surface of the carrier medium directly, that is to say without an adhesive, by way of molecular forces. The cover plate is thus able to be produced in various ways and cost-effectively, in particular.

In one embodiment, it is provided that the cover plate is embodied as bendable. The cover plate can thus be deformed nondestructively, the nondestructive deformation being the case when the cover plate is bent by a bending radius of less than 2 centimeters. The cover plate can thus have for example edge regions in which the cover plate is bent by an angle of 90 degrees, for example. For example, the input coupling region can likewise extend over the bent edge regions, such that light incident there is guided to the image capturing device and thus imaged. As a result, multifunctional cover plates become possible for example for electrical devices having a screen shaped in a correspondingly bent fashion, wherein the input coupling region is positionable in such a way that images can be recorded from a plurality of perspectives, for example from a plurality of sides of the device. As a result, the detection device is embodied in a compatible manner for diversely embodied screens with diversely shaped image display regions.

Another embodiment provides for the image capturing device to be designed to carry out an autofocus function by an edge contrast measurement. An edge contrast measurement denotes a possibility for automatic focusing on an object in the surroundings from which light is recorded by the detection device, by a contrast measurement at contour edges which are recognized in the image data provided, for example by applying methods of digital image processing. Such an edge contrast measurement is able to be realized given a suitable choice of the HOE and of the image capturing device. This makes it possible for a sharp image representation of an object in the surroundings to be made possible by the detection device.

A detection system may include a detection device as described above and a device with a screen. The device may be, for example, a mobile terminal such as, for example, a smartphone, a tablet, a television set or a computer screen. In this case, the detection device is embodied as a cover plate for the screen of the device, that is to say that the detection device provides the cover plate for the screen. The screen includes an image display region, which may occupy the entire screen. The cover plate then serves for example as a protective plate for the image display region and provides the input coupling region on a surface of the cover plate facing away from the screen. Consequently, light may be coupled into the detection device over the entire surface of the cover plate which is arranged on the screen, such that the capture region of the detection device encompasses the entire surface area of the screen. The embodiments presented in association with the detection device and their advantages correspondingly hold true, insofar as applicable, for the detection system. For this reason, the corresponding embodiments of the detection system will not be described again here.

In one advantageous embodiment of the detection system, the image capturing device of the detection device is arranged at one of the following positions: in a frame of the screen of the device; in a cutout in an edge region of the screen of the device; on a lateral wall of the cover plate, wherein the lateral wall is arranged perpendicular to the input coupling region; in the screen of the device. If the device is embodied as a mobile terminal, for example, on the front side of which the display region of the screen is arranged, one or a plurality of sensors, in each case providing the image capturing device, can be arranged in a frame of this image display region of the screen. A plurality of such sensors are expedient, for example, if provision is made of sensors of the image capturing device which are positioned at different positions on account of the wavelength-dependent diffraction of the light that impinges on the input coupling region, which sensors can in each case capture light of different wavelengths and thus light in different color ranges. From the light captured by the various sensors, an evaluation device of the image capturing device will provide the corresponding image data that correlate with the captured light. For this purpose, an edge or frame of the screen having a width of between 1 millimeter and 1 centimeter can be provided, for example. As an alternative or in addition thereto, the image capturing device can be arranged in a cutout in an edge region of the screen. The cutout can be positioned in a corner of the screen, for example. However, an observer wanting to take a photograph of himself/herself using the detection device, for example, does not have to look toward the cutout in the edge region in order to take a photograph of himself/herself in which the observer is looking directly into the image capturing device; rather, the observer can look at the screen centrally, for example, the image data nevertheless showing an image representation of this person in which the latter is looking directly at the image capturing device. This is possible since the light is initially transmitted from the input coupling region through the carrier medium to the output coupling region and is not recorded by the image capturing device itself.

As an alternative or in addition thereto, the image capturing device can be arranged laterally on the carrier medium. The image capturing device is then not visible at all, for example, to a user who is looking at the cover plate and is looking through the cover plate at the image display region of the screen of the device. As an alternative or in addition thereto, the image capturing device can be arranged in the screen of the device itself, for example in the image display region, often referred to as a display. Consequently, there are various possibilities as to how the image capturing device can be integrated into the detection system. Overall, it is thus possible to position the image capturing device in such a way that it is inconspicuous, that is to say invisible to the user, since it does not have to be arranged on the cover plate or in a cutout of the cover plate.

A further embodiment of the detection system provides for the detection device and/or the device to include a light source designed to emit a predefined light pattern to the surroundings. The predefined light pattern can be for example a plurality of light stripes arranged at a predefined distance from one another. The image capturing device is then designed to carry out an autofocus function on the basis of the captured light pattern reflected in the surroundings. In this case, the light pattern emerging from the light source is coupled into the carrier medium through a light pattern input coupling region, is guided through the carrier medium by internal reflection and is caused to emerge into the surroundings in a light pattern output coupling region. The light source, guided through the HOE, may emit infrared light in the form of a predefined light pattern, that is to say as so-called structured light, with the aid of which the autofocus function is carried out. This is a customary method for automatic focusing. In this case, the light pattern input coupling region can correspond to the output coupling region and the light pattern output coupling region can correspond to the input coupling region. However, this is the case only if the light source is correspondingly embodied in the device and/or the detection device itself. A smartphone that is part of the detection system for example as a device with a screen often has such an infrared light source integrated in it, since the light source is used for example for equipping the camera device of the smartphone with the autofocus function. With the aid of the detection system, it is thus possible to provide an autofocus function which enables a focused imaging of an object in the surroundings by the detection device.

One particularly advantageous embodiment of the detection system provides for the device to have a screen side and a rear side situated opposite the screen side. The cover plate is then embodied in bent fashion, that is to say that the cover plate can be deformed nondestructively with a bending radius of less than 2 centimeters. The screen side and the rear side are then covered by the bent cover plate in each case at least regionally. As a result, it is possible, for example, for the above-described cover plate in each case to be arranged both on a front side with the screen and on the opposite rear side of, for example, the smartphone. As a result, for example, an object positioned on the rear side of the smartphone can be captured by the image capturing device since the corresponding light from the surroundings is coupled in at the input coupling region on the rear side of the smartphone, transmitted through the carrier medium and coupled out at the output coupling region, such that the image capturing device can capture and provide the image data correlated with the captured light. As an alternative or in addition thereto, the cover plate can also cover all exterior sides of the device, such that imagings of the surroundings are possible from all sides of the device. However, this is possible only if the input coupling region extends over the entire surface of the cover plate and is arranged in such a way that the input coupling region is arranged on the side of the cover plate facing away from the device.

### BRIEF DESCRIPTION OF THE DRAWINGS

These and other aspects and advantages will become more apparent and more readily appreciated from the following description of the exemplary embodiments, taken in conjunction with the accompanying drawings of which:

These and other aspects and advantages will become more apparent and more readily appreciated from the following description of the exemplary embodiments, taken in conjunction with the accompanying drawings of which:

FIG. 1 is a schematic perspective view of a detection device positioned on a screen,

FIGS. 2a-2c are partial schematic front views of a smartphone with in each case at least one image capturing device, and

FIG. 3 is a schematic perspective view of a smartphone covered by a cover plate of a detection device on a screen side and a rear side.

### DETAILED DESCRIPTION

In the exemplary embodiments explained below, the described components of the embodiments each constitute individual features which should be considered independently of one another and which each also develop the invention independently of one another. Therefore, the disclosure is also intended to encompass combinations of the features of the embodiments other than the combinations presented. Furthermore, the embodiments described can also be supplemented by further features from among those already described.

In the figures, identical reference signs in each case designate functionally identical elements.

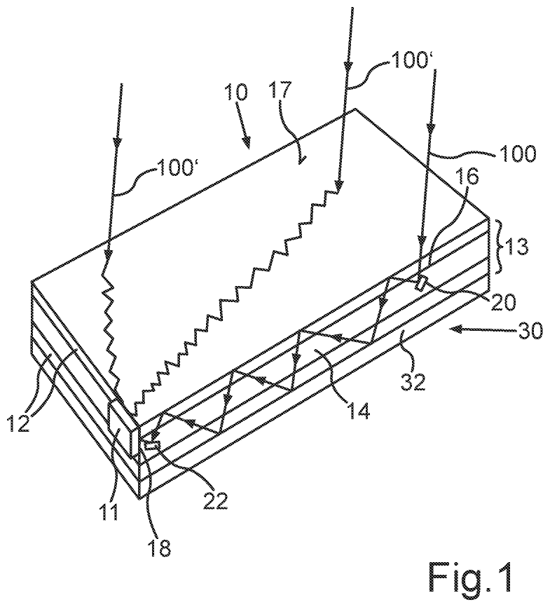

FIG. 1 schematically depicts a detection device 10 with an image capturing device 11 and a carrier medium 12. In this case, the carrier medium 12 is embodied as a light guide and provides an input coupling region 16 and an output coupling region 18. The carrier medium 12 is embodied together with the input coupling region 16 and the output coupling region 18 as a cover plate 13. The cover plate 13 is designed to be arranged on a screen 32, which is not part of the detection device 10. In this case, the cover plate 13 covers a display region of the screen 32. The input coupling region 16 may be provided in at least one partial region of a surface of the detection device 10, that is to say a cover plate surface 17 of the cover plate 13. The partial region may be configured to cover at least the image display region of the screen 32.

The input coupling region 16 is embodied as a holographic element 14 with a first deflection structure 20. The deflection structure 20 is configured to couple light 100 that is incident on the first deflection structure 20 from the surroundings into the carrier medium 12. In this example, the light 100 is depicted schematically in the form of a light ray that passes through the cover plate surface 17 and is deflected by the first deflection structure 20. Moreover, further light rays are depicted schematically as light 100′, these further light rays likewise impinging on the input coupling region 16. The carrier medium 12 is configured to transmit the coupled-in light 100 from the input coupling region 16 to the output coupling region 18 by internal reflection. The output coupling region 18 is embodied as a holographic element 14 with a second deflection structure 22. The second deflection structure 22 is designed to couple the transmitted light 100 that is incident on the second deflection structure 22 out of the carrier medium 12.

The image capturing device 11 is arranged here on a lateral wall of the carrier medium 12, that is to say on a lateral wall of the cover plate 13, wherein the lateral wall is arranged perpendicular to the input coupling region 16 and thus to the cover plate surface 17. The image capturing device 11 is configured to capture the coupled-out light 100 and to provide it in the form of image data that correlate with the captured light 100.

It should be noted that the input coupling region 16 and the output coupling region 18 have at least one optical grating, in particular a volume holographic grating or a surface holographic grating, as deflection structure 20, 22. In this case, the input coupling region 16 and the output coupling region 18 can be embodied integrally with the carrier medium 12. As an alternative thereto, the carrier medium 12 can be embodied as a separate element with respect to the input coupling region 16 and the output coupling region 18. The image capturing device 11 is distinguished by the fact that it can carry out an autofocus function by an edge contrast measurement.

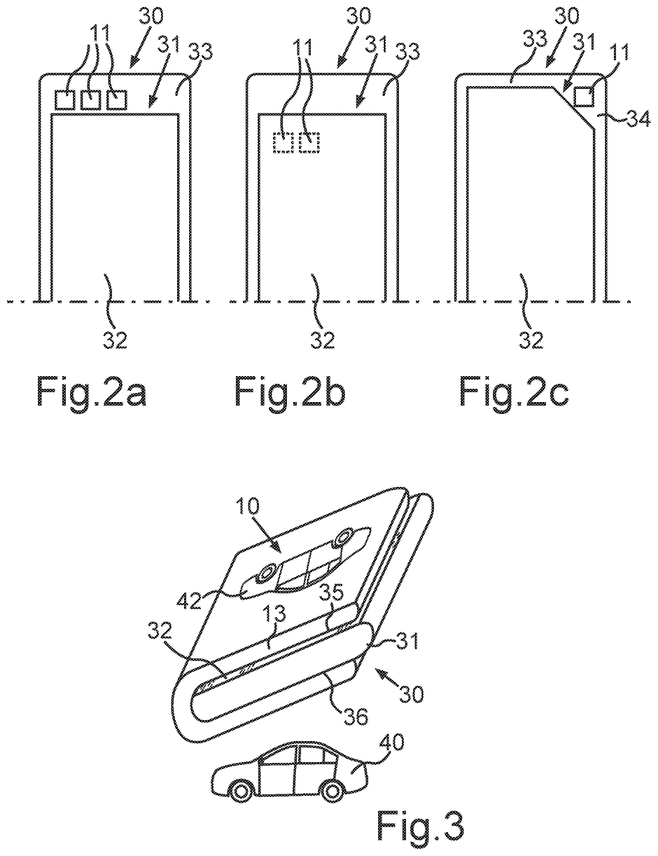

In addition, FIG. 1 schematically depicts a detection system 30. The detection system 30 includes the detection device 10 and the screen 32 of a device 31 (represented by the reference sign 31 in FIG. 2). The device 31 may be for example a mobile terminal, that is to say a smartphone, a computer screen, a tablet and/or a television set. The detection device 10 provides the cover plate 13 for the screen 32 of the device 31.

FIGS. 2a to 2c respectively reveal various positions at which the image capturing device 11 can be positioned. FIGS. 2a to 2c here show in each case a front side of a smartphone, that is to say the front side of the device 31. The device 31 has in each case a screen 32, the image display region of which is surrounded by a frame 33. The image capturing device 11 can then be arranged in the frame 33 of the screen 32 of the device 31, for example, as depicted schematically in FIG. 2a. In this case, a plurality of image capturing devices 11 can be provided, for example, which are each designed for example to capture light 100 in a specific wavelength range from the output coupling region 18 and to provide it in the form of corresponding image data. In this case, the image capturing device 11 additionally includes an evaluation device, which is not depicted schematically in FIGS. 2a to 2c, which is designed to provide, from the image data provided by the plurality of image capturing devices 11, final image data that correlate with the captured light 100 from the surroundings and optionally to display them on the screen 32. In FIG. 2b, two image capturing devices 11 are positioned in the screen 32 of the device 31. In FIG. 2c, an exemplary image capturing device 11 is arranged in a cutout 34 of the frame 33 of the screen 32. In this example, the input coupling region 16 may extend in each case over the entire cover plate surface of the cover plate 13, that is to say of the screen 32. If, for example, a user of the device 31 then wants to take a photograph of himself/herself, the user does not have to look into one of the image capturing devices 11, but rather can direct his/her gaze centrally at the screen 32, for example. What is achieved as a result is that no parallax effect occurs for the user when recording a photograph of himself/herself.

FIG. 3 schematically depicts the detection device 10 with a bendable cover plate 13. The bendable cover plate 13 is embodied in such a way that it covers both a screen side 35 of the screen 32 of the device 31 and a rear side 36 of the device 31. In this example, the screen side 35 and the rear side 36 are covered by the cover plate 13 in each case at least partly. If a toy automobile 40 is then situated in the surroundings of the rear side 36 of the device 31, for example, light 100 describing the toy automobile can be “captured” by the input coupling region 16 on the rear side 36 of the cover plate 13 and can be guided by the carrier medium 12 to the output coupling region 18 and to the image capturing device 11, such that ultimately an imaging 42 of the toy automobile 40 can be displayed on the screen 32.

The detection device 10 and/or the device 31 additionally include(s) a light source designed to emit a predefined light pattern into the surroundings. The image capturing device 11 is designed to carry out an autofocus function on the basis of the captured light pattern reflected in the surroundings, wherein the light pattern emerging from the light source is coupled into the carrier medium 12 through a light pattern input coupling region, corresponding to the output coupling region 18, for example, is guided through the carrier medium 12 by internal reflection and emerges into the surroundings in a light pattern output coupling region, corresponding to the input coupling region 16, for example.

Overall, the examples show how a cellular phone display with an invisible recording function can be realized. For this purpose, a so-called HoloCam is installed in the cover plate 13 of the device 31, which is for example a smartphone, that is to say a cellular phone. A holographic element 14 is thus integrated into the cover plate 13. The use of such a cover plate 13, shaped for example as display protective glass, makes it possible to fit the image capturing device 11 outside the image display region of the screen 32 and in this case at the same time to use the surface area of the screen 32 for recording. This eliminates disturbing elements in the image display region of the screen 32, such as the cutout 34, for instance, which can also be referred to as a notch, in order to position for example a camera sensor there. As a result of the enlargement of the recording region over the entire surface area of the input coupling region 16, shading, for example caused by a finger of the user, is unlikely. Moreover, optical elements of typical camera devices can be obviated, whereby costs, weight and complexity of the device can be reduced. Furthermore, diverse functions can be represented, such as, for example, a distance measurement by way of contrast, that is to say an edge contrast measurement, or a structured light application, that is to say an autofocusing with the aid of light patterns. For this purpose, a conventional screen surface composed of glass is replaced by the cover plate 13. The cover plate 13, which is part of the detection device 10, makes it possible for the light 100 that impinges on the cover plate surface 17 to be deflected to an image capturing device 11 situated outside the screen 32 of the device 31 and to be coupled out there.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. A detection device used in surroundings in conjunction with a screen having an image display region, comprising:
a carrier medium embodied as a light guide having an input coupling region and an output coupling region, and formed as a cover plate for the image display region of the screen,
the input coupling region provided in at least one partial region of a cover plate surface of the cover plate, the at least one partial region covering the image display region, as a first holographic element with a first deflection structure to couple light incident on the first deflection structure from the surroundings into the carrier medium and by the carrier medium from the input coupling region to the output coupling region by internal reflection, and
the output coupling region embodied as a second holographic element with a second deflection structure to couple the light incident on the second deflection structure out of the carrier medium; and
an image capturing device configured to capture the light coupled out of the output coupling region and provide image data correlated with the light.

11. The detection device as claimed in claim 10, wherein the input coupling region and the output coupling region each have at least one of a volume holographic grating and a surface holographic grating.

12. The detection device as claimed in claim 11, wherein the input coupling region and the output coupling region are one of embodied integrally with the carrier medium and embodied separately from the carrier medium.

13. The detection device as claimed in claim 12, wherein the cover plate is bendable.

14. The detection device as claimed in claim 13, wherein the image capturing device is configured to perform an autofocus function by an edge contrast measurement.

15. The detection device as claimed in claim 10, wherein the input coupling region and the output coupling region are one of embodied integrally with the carrier medium and embodied separately from the carrier medium.

16. The detection device as claimed in claim 10, wherein the cover plate is bendable.

17. The detection device as claimed in claim 10, wherein the image capturing device is configured to perform an autofocus function by an edge contrast measurement.

18. A detection system used in surroundings, comprising:
a user device with a screen having an image display region; and
a detection device, including
a carrier medium, embodied as a light guide having an input coupling region and an output coupling region, and providing a cover plate over the screen of the device,
the input coupling region, provided in at least one partial region of a cover plate surface of the cover plate, the at least one partial region covering the image display region, as a first holographic element with a first deflection structure to couple light incident on the first deflection structure from the surroundings into the carrier medium and by the carrier medium from the input coupling region to the output coupling region by internal reflection, and
the output coupling region embodied as a second holographic element with a second deflection structure to couple the light incident on the second deflection structure out of the carrier medium; and
an image capturing device configured to capture the light coupled out of the output coupling region and provide image data correlated with the light.

19. The detection system as claimed in claim 18, wherein the image capturing device of the detection device is arranged at one of:
in a frame of the screen of the device,
in a cutout in an edge region of the screen of the device,
on a lateral wall of the cover plate, arranged perpendicular to the input coupling region, and
in the screen of the device.

20. The detection system as claimed in claim 19,
wherein at least one of the detection device and the device includes a light source configured to emit a predefined light pattern into the surroundings,
wherein the image capturing device is configured to perform an autofocus function based on a captured light pattern reflected from the surroundings, and
wherein the carrier medium further includes
a light pattern input coupling region, configured to couple the light pattern emitted by the light source into the carrier medium, and
a light pattern output coupling region receiving the light pattern from the light pattern input coupling region via internal reflection in the carrier medium, and configured to output the light pattern into the surroundings.

21. The detection system as claimed in claim 20, wherein the device has a screen side and a rear side situated opposite the screen side,
wherein the cover plate is bent and at least partially covers each of the screen side and the rear side.

22. The detection system as claimed in claim 18,
wherein at least one of the detection device and the device includes a light source configured to emit a predefined light pattern into the surroundings,
wherein the image capturing device is configured to perform an autofocus function based on a captured light pattern reflected from the surroundings, and
wherein the carrier medium further includes
a light pattern input coupling region, configured to couple the light pattern emitted by the light source into the carrier medium, and
a light pattern output coupling region receiving the light pattern from the light pattern input coupling region via internal reflection in the carrier medium, and configured to output the light pattern into the surroundings.

23. The detection system as claimed in claim 18, wherein the device has a screen side and a rear side situated opposite the screen side,
wherein the cover plate is bent and at least partially covers each of the screen side and the rear side.

24. The detection system as claimed in claim 18, wherein the input coupling region and the output coupling region each have at least one of a volume holographic grating and a surface holographic grating.

25. The detection system as claimed in claim 24, wherein the input coupling region and the output coupling region are one of embodied integrally with the carrier medium and embodied separately from the carrier medium.

26. The detection system as claimed in claim 25, wherein the image capturing device is configured to perform an autofocus function by an edge contrast measurement.

27. The detection system as claimed in claim 18, wherein the input coupling region and the output coupling region are one of embodied integrally with the carrier medium and embodied separately from the carrier medium.

28. The detection system as claimed in claim 18, wherein the image capturing device is configured to perform an autofocus function by an edge contrast measurement.
